(19) United States
(12) Patent Application Publication
(10) Pub. No.: US 2025/0272470 A1
(43) Pub. Date: Aug. 28, 2025

(54) LANGUAGE INDEPENDENT TEXTUAL EXTRACTION

(71) Applicant: ITERATE STUDIO, INC., Highlands Ranch, CO (US)

(72) Inventors: Brainerd Sathianathan, Morgan Hill, CA (US); Charangan Vasantharajan, Toronto (CA); Shomron Jacob, San Jose, CA (US)

(73) Assignee: ITERATE STUDIO, INC., Highlands Ranch, CO (US)

(21) Appl. No.: 18/590,347

(22) Filed: Feb. 28, 2024

(51) Int. Cl. G06F 40/103; G06F 40/177; G06V 30/16; G06V 30/412; G06V 30/414

(52) U.S. Cl. CPC G06F 40/103; G06F 40/177; G06V 30/16; G06V 30/412; G06V 30/414

(57) ABSTRACT

A language independent optical character recognition process (LIOP) is disclosed. The LIOP detects text in one or more tables in a document, where the document is language dependent. Structural information for each table is determined and the text is extracted from the table(s). The document is converted into a first file format, where the first file format is a structured file format. The document in the first file format is language independent.

### TECHNICAL FIELD

The technology described herein relates generally to textual extraction and document reproduction utilizing language independent optical character recognition.

### BACKGROUND

A document can be complex in that the document may be written in one or more languages and include different types of elements, such as text and typefaces, graphics, tables, pictures, lists, and formatting. Due to this complexity, it can be difficult for an optical character recognition (OCR) process to convert an image of the document into an electronic version of the document (e.g., machine-readable text). Because different languages have different characters, grammar, and sentence structure, OCR processes are customized for each language. One OCR process is used on a document written in the English language while a different OCR process is used on a document written in the Russian language and another different OCR process is used on a document written in the Japanese language.

OCR processes are also typically customized for different types of content and styles. For example, one OCR process can be customized for tables while another OCR process is customized for lists. Creating customized OCR processes is challenging and costly due to the significantly high number of language, content, and style permutations that must be considered.

### SUMMARY

Embodiments disclosed herein provide techniques to enable language independent OCR that can be readily applied to one or more tables in documents. The techniques may be used with documents that include text in different languages, graphics, images, and other data. Each table can be a defined or explicit table, an undefined or implicit table, a defined subtable (e.g., a table within a table), and/or an undefined subtable.

In one aspect, a method includes detecting a table in a document, where the document is language dependent. A document is language dependent in that the document includes text written in one or more languages and/or a particular style or type of content. Text in the table is detected and structural information for the table is determined. The text in the table is extracted from the table. The document is converted into a first file format, where the first file format is a structured file format and the document in the first file format is language independent. The first file format is language independent in that a computing process (e.g., a machine learning process) does not need to understand the language(s), the particular style or the type of content. The document can be reconstructed into a second file format and output. For example, the document can be displayed, printed, and/or stored in a memory. The table in the document is reconstructed into the second file format based on the text extracted from the table and the structural information.

In another aspect, a method includes receiving a document and determining if the document is similar to one of a plurality of reference documents. Based on a determination that the document is similar to one of the plurality of reference documents, the document is reconstructed into a first file format based on the text in the document and the reference document. Based on a determination that the document is not similar to one of the plurality of reference documents, a table in the document is detected and the text in the table is detected. Structural information for the table is determined. Determining the structural information includes detecting locations of the text in the table. The text is extracted from the table and the document is converted into a first file format. The first file format is a structured file format and the document in the first file format is language independent. The document is reconstructed into a second file format and output. The table is reconstructed into the second file format based on the text extracted from the table and the structural information.

In yet another embodiment, a system includes a processing device and a memory. The memory is operable to store instructions, that when executed by the processing device, cause operations to be performed. The operations include detecting, using an optical character recognition process, text in a table in a document and creating, using an object detection process, bounding boxes around the text in the table. Structural information for the table is determined. Determining the structural information includes detecting rows and columns in the table and detecting a location of each bounding box in a respective row and a respective column. The detected rows, the detected columns, and the location(s) of the bounding box(es) comprises the structural information. The text is extracted from the table and the document is converted into a first file format. The first file format is a structured file format and the document in the first file format is language independent. Using a large language model, the document is reconstructed into a second file format and output. The table is reconstructed into the second file format based on the text extracted from the table and the structural information.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates a flowchart of a method of a language independent OCR process in accordance with an embodiment of the disclosure;

FIG. 2 illustrates a flowchart of an example method of determining the structural information for the table in accordance with an embodiment of the disclosure;

FIG. 3 illustrates multiple text bounding boxes in accordance with an embodiment of the disclosure;

FIG. 4 illustrates an example document in accordance with an embodiment of the disclosure;

FIG. 5 illustrates the lower portion of the example document shown in FIG. 4 after an object detection process is performed in accordance with an embodiment of the disclosure;

FIG. 6 illustrates the example lower portion shown in FIG. 5 after horizontal lines and vertical lines are created for each text bounding box in accordance with an embodiment of the disclosure;

FIG. 7 illustrates a flowchart of an example method of determining a structure of the table in accordance with an embodiment of the disclosure;

FIG. 8 illustrates an expanded view of the lower portion of the example document shown in FIG. 6 with horizontal boxes and vertical boxes in accordance with an embodiment of the disclosure;

FIG. 9 illustrates the non-overlapping horizontal boxes shown in FIG. 8 in accordance with an embodiment of the disclosure;

FIG. 10 illustrates the non-overlapping vertical boxes shown in FIG. 8 in accordance with an embodiment of the disclosure;

FIG. 11 illustrates a flowchart of an example method of a workflow in accordance with an embodiment of the disclosure;

FIG. 12 illustrates the example document shown in FIG. 4 with the text extracted in an embodiment in accordance with the disclosure;

FIG. 13 illustrates an example block diagram of an environment in which a language independent OCR process can operate in accordance with an embodiment of the disclosure; and

FIG. 14 illustrates an example block diagram of a computing device in accordance with an embodiment of the disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure includes techniques to enable language independent OCR that can be readily applied to documents including text in different languages, while also recreating and/or analyzing data in image, portable document format (PDF), or other types of digital documents or files. In one example, a document is analyzed, e.g., by a machine learning model, to identify certain document structural features, e.g., tables, within the document. As the structural features (e.g., tables) are identified, text can be separated from the structural features of the document, and extracted. The extracted text, along with the structural information regarding the position of the text (e.g., the location of the extracted text within an identified table in the document) can be provided a translating model, such as a large language model (LLM) or other machine learning model. The translating model, which may be trained on multiple languages and documents, can utilize both the textual information, as well as structural information, to recreate the document in another format, such as a digital format. This allows the accurate and efficient analysis and recreation of various types of documents and files that may include text within tables or other structural features, including documents in multiple languages, which is not possible with current OCR technologies.

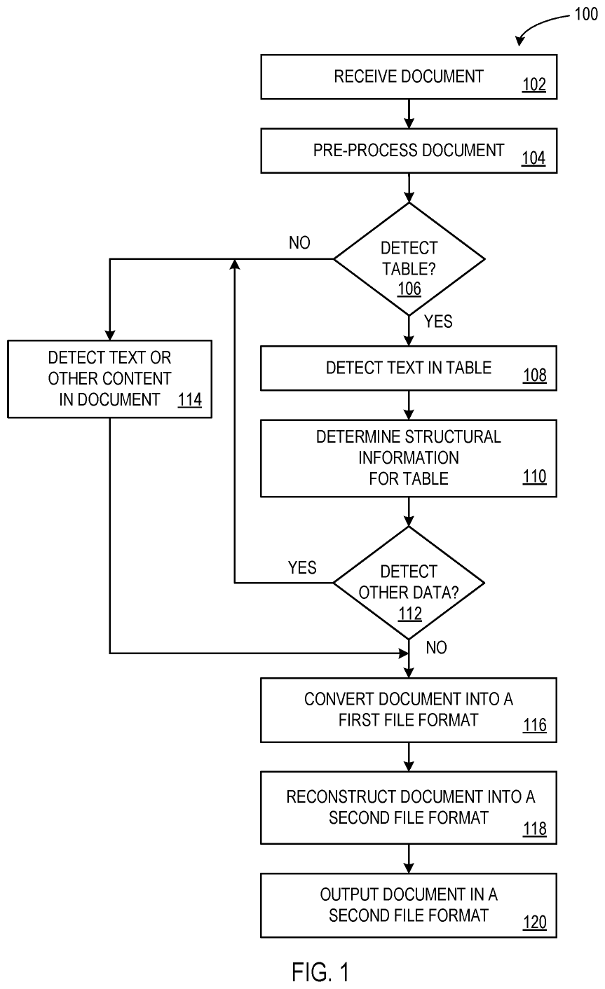

FIG. 1 illustrates a flowchart of a method of a language independent OCR process in accordance with an embodiment of the disclosure. The method 100 begins with the receipt of a document at block 102. The term “document” can refer to an image of a document (e.g., a scanned image of a document), a document, a page in a document, a portion of a page of a document, or a portion of a document. The document is language dependent in that the document includes text written in one or more languages and/or a particular style or type of content. The text can include attributes associated with particular values. For example, an attribute may be “Hospital Name” and the associated value is “General Hospital.” Some of the text may be arranged in a table format (e.g., one or more rows or columns), while other text is not included in a table.

Next, one or more pre-processing operations is performed at block 104. Non-limiting nonexclusive examples of pre-processing operations include noise reduction, thresholding, skew correction, normalization, image scaling, image rotation, and sharpening. For example, certain documents, such as a PDFs, may be created via a scanning process that may tilt or skew aspects of the content, blur the content or the like. One or more pre-processing operations corrects such issues that may be separate from the text and/or structural features of the document content.

A determination is made at block 106 as to whether one or more tables is detected in the document. In one embodiment, table detection using a deep learning model is employed to detect one or more tables in the document. One example of a table detection process is a table transformer. One or more defined or explicit tables, undefined or implicit tables, defined subtables (e.g., a table within a table), and/or undefined subtables may be detected by the table detection using the deep learning model.

If a determination is made at block 106 that a table is detected, the method continues at block 108 where an OCR process is performed to detect the text in the table. At block 110, structural information for the table is determined. The structural information includes the detected text in the table, the location of one or more defined or explicit tables, undefined or implicit tables, defined subtables (e.g., a table within a table), undefined subtables, the format of each table and subtable, and the location and formatting of text that is not included in any tables or subtables. For each table and subtable, the structural information includes the text, the locations of the text, the detected rows (e.g., the location of the rows), the detected columns (e.g., the location of the columns), and the headers in the table or subtable. For simplicity, the term table covers defined and undefined tables and undefined and defined subtables.

A determination is made at block 112 as to whether other data is detected in the document. Other features in the document, such as graphs, geometric structures, text that is not in a table, images, or the like may be present in the document. If a determination is made that other data is detected in the document, the method passes to block 114 where the other data is identified.

After block 114, or when a determination is made at block 112 that other data is not detected in the document, the method proceeds at block 116 where the document is converted into a first file format. Generally, the document (e.g., the text, tables, etc.) is recreated in the first file format such that the converted document reflects the original document that was received at block 102. However, the document in the first file format is language independent, which means a computing process (e.g., a machine learning process) does not need to understand the text in one or more languages, does not need to recognize that a value is associated with a particular attribute, does not need to understand the structure of the document, or the structure of any tables. The first file format is a structured file format in one embodiment. For example, a structured file format can be a file format in which both the data (e.g., text, graphics, images, etc.) and the file structure are stored in the same file. As another example, a structured file format may be a file format that includes the data and preserves the whitespaces in the document. In a non-limiting nonexclusive example, the first format is a comma-separated values (CSV) file format, although other file formats can be used in other embodiments.

At block 118, the document in the first file format is reconstructed into a second file format. The table is reconstructed into the second file format based on the text extracted from the table and the structural information determined for the table. As will be described in more detail later, an LLM is used to reconstruct the document into the second file format. In general, an LLM is a type of artificial intelligence program that uses deep learning techniques to, among other tasks, recognize, generate, and predict human language (e.g., text). LLMs are built on machine learning and are trained on very large sets of data. For example, an LLM can be trained on terabytes of data. LLMs can also be further trained by prompts that are directed at a particular task. In one embodiment, the LLM that is used to reconstruct the document into the second file format is trained on, among other subjects, different languages, different document types, and different document formats. The prompts can be directed to, for example, different document types and different document formats.

The second file format is the JavaScript Object Notation (JSON) file format in an example embodiment, although different file formats can be used in other embodiments. The LLM organizes and formats the text, the tables, and any other data in the document into the JSON format based on the first file format (e.g., the data in the first file format).

The document in the second file format is then output at block 120. For example, the document in the second file format can be displayed to a user, transmitted to a computing device, and/or saved in memory. Returning to block 106, when a determination is made that a table is not detected in the document, the method continues at block 114 and block 116, block 118, and block 120 are performed. The data detected at block 114 (and at block 112) is processed differently from how the data in a table is processed. Block 108 and block 110 are performed for data (e.g., text) in a table. The data detected at block 112 and at block 114 are passed to block 116 and organized in the first file format at block 116.

Although the method is described as detecting one table, other embodiments may detect multiple tables and each table is processed as described herein. Additionally, although the method 100 is illustrated as including particular operations performed in a depicted order, more or fewer operations can be included, and the operations can be performed in a different order, including performing one or more operations in parallel.

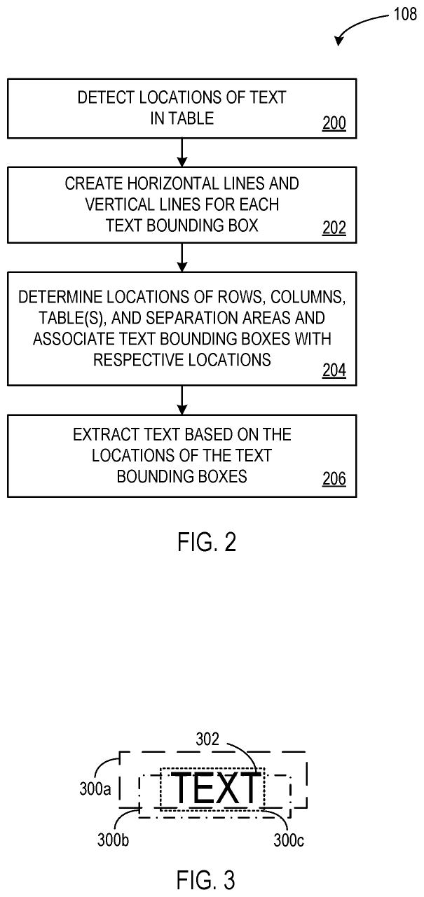

FIG. 2 illustrates a flowchart of an example method of determining the structural information for the table in accordance with an embodiment of the disclosure. The depicted method is performed at block 110 in FIG. 1. Initially, as shown in block 200, the locations of the text detected in the table (at block 108) are determined. In a non-limiting nonexclusive example, an object detection process is used to determine the locations of the detected text. The object detection process can create bounding boxes for the detected text (herein “text bounding box”). Each text bounding box provides positional information that identifies the location of the detected text within the document. For example, the text bounding box may provide (x, y) coordinates for the detected text. A non-limiting nonexclusive example of an object detection process is a non-maximum suppression (NMS) process.

In some embodiments, the object detection process creates multiple text bounding boxes 300a, 300b, 300c around the text 302, as shown in FIG. 3. Each text bounding box 300a, 300b, 300c may be a different sized bounding box and can be located at a different position with respect to the text 302. The object detection process selects the most suitable text bounding box by generating a score for each text bounding box 300a, 300b, 300c based on the position of the text bounding box 300a, 300b, 300c with respect to the text 302. For example, the text bounding box 300c can be associated with a higher score because the text bounding box 300c encompasses the entire text 302 with a lower amount of unused area (e.g., white space) within the text bounding box 300c. The text bounding box 300b is associated with a lower score compared to the score of the text bounding box 300c because the text bounding box 302b does not encompass the entire text (e.g., upper portions of the characters in the text 302 are not within the text bounding box 300b) and/or because the text bounding box 300b includes a larger amount of unused area. The text bounding box 300a is associated with a lower score compared to the score of the text bounding box 300c because the text bounding box 300a includes a larger amount of unused space. For each text in the table, the object detection process retains the text bounding box with the highest score and discards the other text bounding boxes.

Referring again to FIG. 2, horizontal lines and vertical lines are created for each text bounding box (block 202). In one embodiment, horizontal lines and vertical lines extend along the periphery of each text bounding box. For example, the horizontal lines abut or are adjacent to the horizontal edges of each text bounding box and the vertical lines abut or are adjacent to the vertical edges of each text bounding box.

The locations of the table(s), the rows, the columns, the separation areas (e.g., the whitespaces between the text bounding boxes), and the locations of the text bounding boxes are determined at block 204. Each text bounding box is associated with a respective location (e.g., a respective row and a respective column) in the table. Next, as shown in block 206, the text is extracted from the document based on the detected locations of the text bounding boxes. It should be noted that in other embodiments, other types of bounding boxes or geometric shapes may be used to identify the text or structural features within the table.

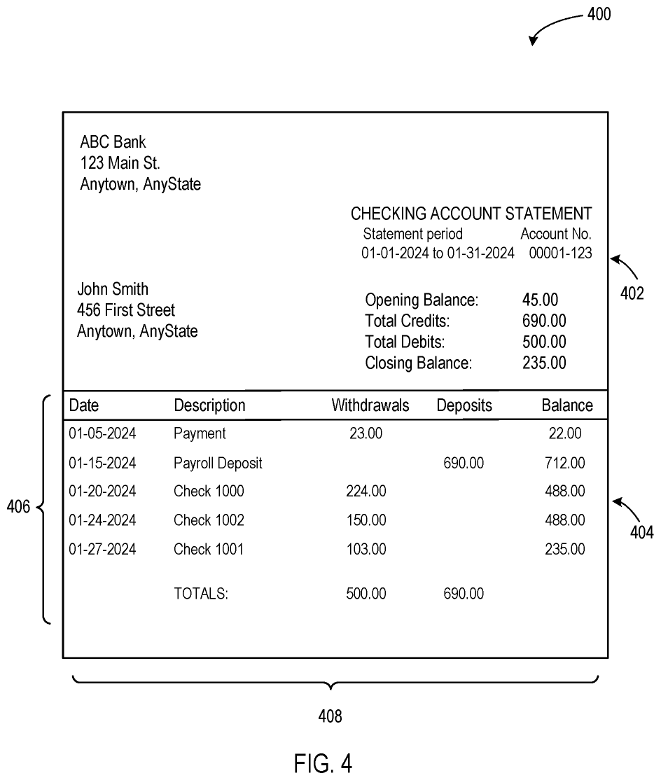

FIG. 4 illustrates an example document in accordance with an embodiment of the disclosure. The example document 400 can be received at block 100 in FIG. 1. The example document 400 is a bank statement that includes an upper portion 402 and a lower portion 404. The text in the lower portion 404 is arranged in rows 406 and columns 408 in a table. The table in the lower portion 404 is an example of a defined table that would be detected at block 106 in FIG. 1, while the data in the upper portion 402 would be detected at block 112.

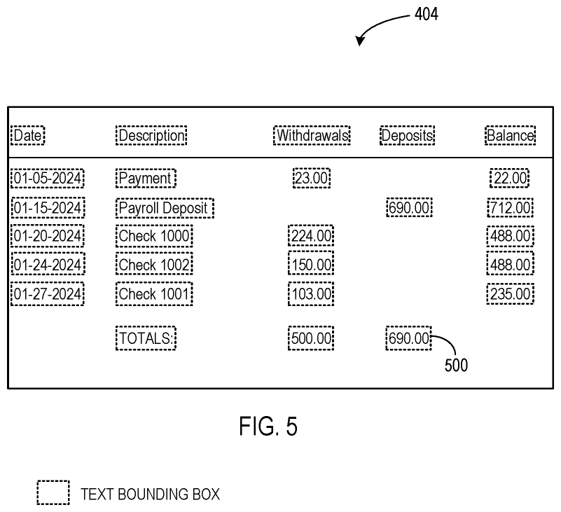

FIG. 5 illustrates the lower portion of the example document shown in FIG. 4 after an object detection process is performed in accordance with an embodiment of the disclosure. The illustrated lower portion is depicted after block 200 in FIG. 2 is performed. The text bounding boxes 500 with the highest scores are shown in the illustrated figure. As discussed earlier, each text bounding box 500 provides positional information for the text associated with that text bounding box 500.

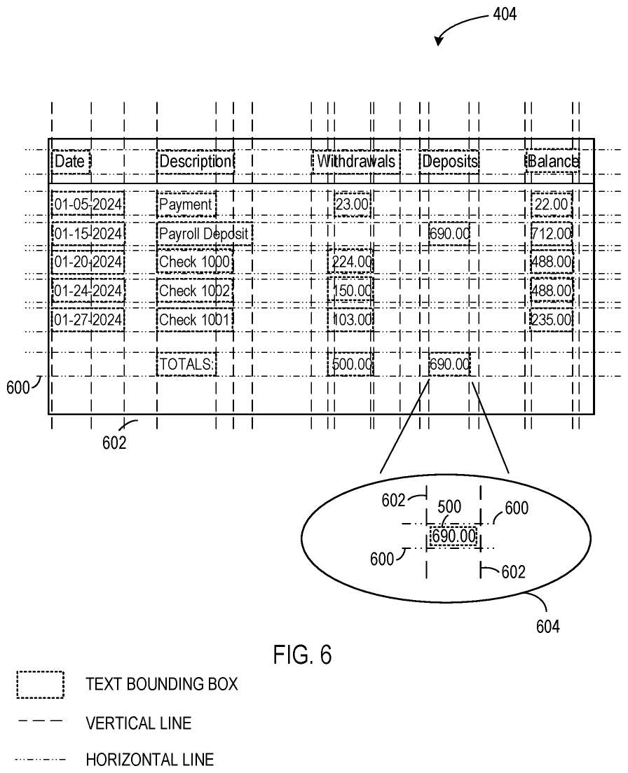

FIG. 6 illustrates the example lower portion shown in FIG. 5 after horizontal lines and vertical lines are created for each text bounding box in accordance with an embodiment of the disclosure. As described earlier, horizontal lines 600 and vertical lines 602 are produced for each text bounding box at block 202 in FIG. 2. For clarity, the horizontal lines 600 and the vertical lines 602 extend outside the boundary of the lower portion 404. In some embodiments, the horizontal lines 600 and/or the vertical lines 602 do not extend outside the boundary of the lower portion 404.

In one embodiment, a horizontal line 600 is provided for and abuts each horizontal line of the text bounding boxes 500, and a vertical line 602 is provided for and abuts each vertical line of the text bounding boxes 500. This is depicted in the expanded area 604. As shown in FIG. 6, some of the vertical lines 602 extend into and through some of the text bounding boxes 500. Although not shown in FIG. 6, in some embodiments, some of the horizontal lines 600 may extend into and through some of the text bounding boxes 500. The horizontal lines 600 and the vertical lines 602 are used to produce horizontal boxes and vertical boxes. As will be described in more detail later, the horizontal boxes and vertical boxes can be used to determine the locations of the rows, the columns, the tables, and the separation areas in the document. The horizontal boxes and the vertical boxes may also be used to associate the text bounding boxes 500 with locations within the table.

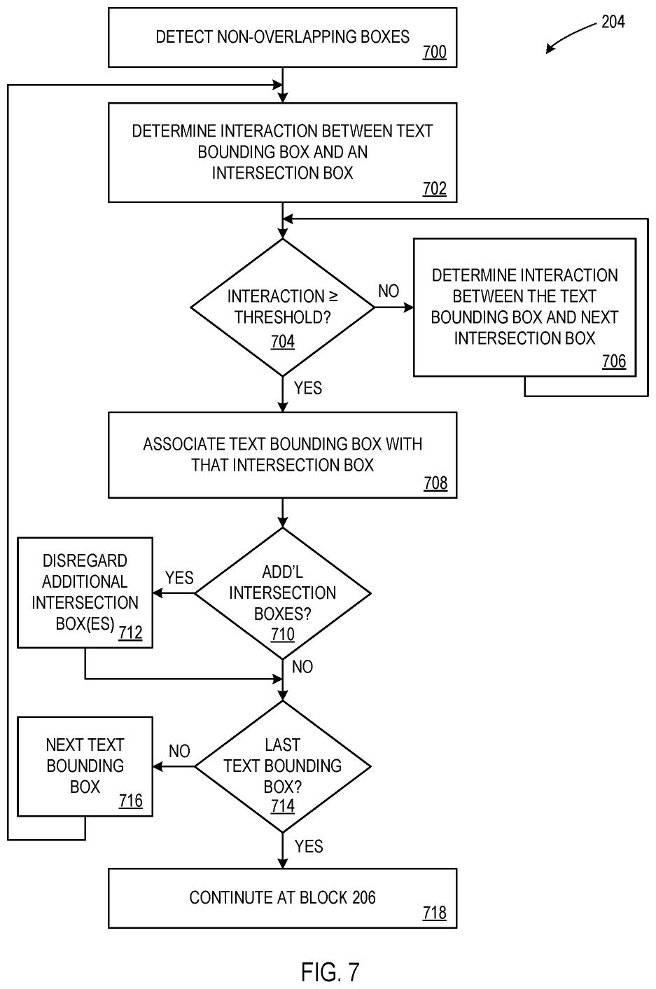

FIG. 7 illustrates a flowchart of an example method of determining a structure of the table in accordance with an embodiment of the disclosure. The structure of the table includes the locations of rows, columns, separation areas, and bounding boxes. The method depicted in FIG. 7 can be performed at block 204 in FIG. 2.

Initially, as shown in block 700, non-overlapping horizontal boxes and non-overlapping vertical boxes are determined based on the horizontal lines and the vertical lines. In an example embodiment, the object detection process is used to determine the non-overlapping horizontal boxes and the non-overlapping vertical boxes in the document. The non-overlapping horizontal boxes can provide the rows and separation areas adjacent to the rows in the document and in any tables in the document. The non-overlapping vertical boxes may provide the columns and the separation areas adjacent to the columns in the document and in any tables in the document.

After block 700, the method iteratively analyzes each text bounding box with respect to a particular intersection box. An intersection box is a box that is defined by one of a non-overlapping horizontal box and one of a non-overlapping vertical box. Next, as shown in block 702, the interaction between a respective text bounding box and an intersection box is determined. The intersection box may be a corresponding intersection box, where a corresponding intersection box is a box in which the respective text bounding box resides, either wholly or partially, within that intersection box. Thus, the analysis of a respective text bounding box in the document is limited to the corresponding intersection boxes and does not include all of the intersection boxes in the document, in a corresponding non-overlapping horizontal box, and/or in a corresponding non-overlapping vertical box. In other embodiments, all of the intersection boxes in the document, in a non-overlapping horizontal box, and/or in a non-overlapping vertical box may be included in the analysis of each respective text bounding box.

In one embodiment, an intersection over union (IoU) process is performed to determine the interaction between a respective text bounding box and a corresponding intersection box. The IoU process compares the area of the respective text bounding box with the area of the corresponding intersection box. The result of the comparison represents the interaction of the respective text bounding box with the corresponding intersection box.

A determination is made at block 704 as to whether the interaction is equal to or greater than a threshold. If a determination is made that the interaction is not equal to or greater than the threshold, the method continues at block 706 where the interaction between the respective text bounding box and another corresponding intersection box is determined. The method then returns to block 704 and repeats until the interaction between the respective text bounding box and a corresponding intersection box is equal to or greater than the threshold.

When the interaction between the respective text bounding box and the corresponding intersection box is equal to or greater than the threshold, the method passes to block 708, where the respective text bounding box is associated with that corresponding intersection box. The location of the respective text bounding box is determined to reside within that corresponding intersection box. The location of the respective text bounding box is determined to reside within a particular horizontal box and a particular vertical box that corresponds to the intersection box.

For example, when at least a given percentage of the area of the text bounding box is within the area of a corresponding intersection box, the text bounding box is associated with that intersection box. The given percentage can be the same percentage value for all of the intersection boxes in a row, a column, and/or a document or the given percentage can differ for at least one intersection box in a row, a column, and/or a document.

A determination is then made at block 710 as to whether one or more additional corresponding intersection boxes overlap or are contained within that text bounding box. If a determination is made that there is at least one additional corresponding intersect box, the method proceeds at block 712 where each additional corresponding intersection box is disregarded since the location of the text bounding box has already been associated with a respective corresponding intersection box. After block 712, or when a determination is made at block 710 that there are no additional corresponding intersection boxes, the method continues at block 714 where a determination is made as to whether the last text bounding box in the table has been analyzed. If a determination is made that the last text bounding box has not been analyzed, the method continues at block 716 where the next text bounding box is selected and the method returns to block 702. When a determination is made that the last text bounding box has been analyzed, the method passes to block 718 where the method continues at block 206 in FIG. 2.

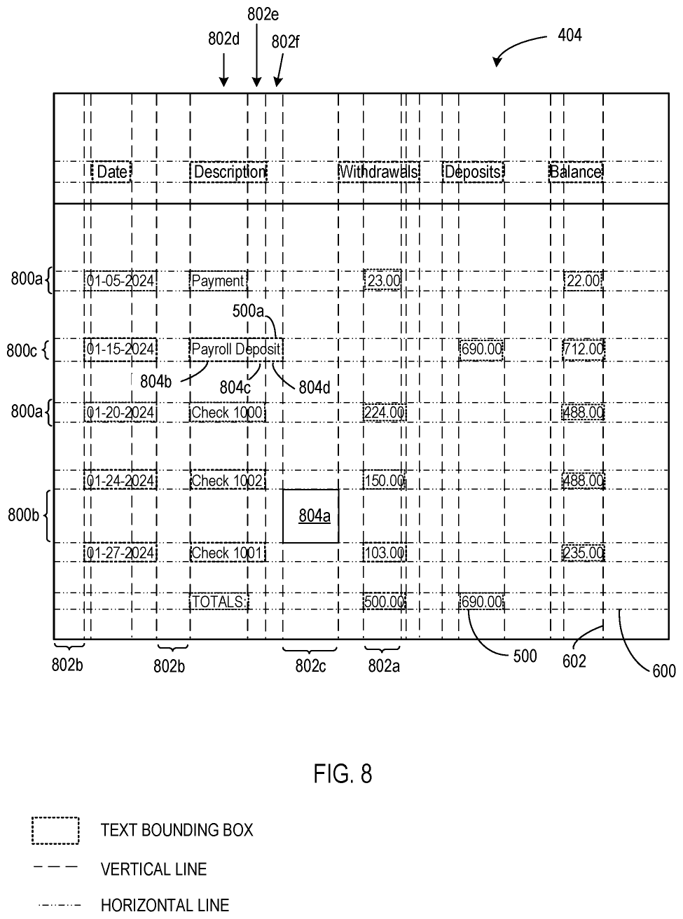

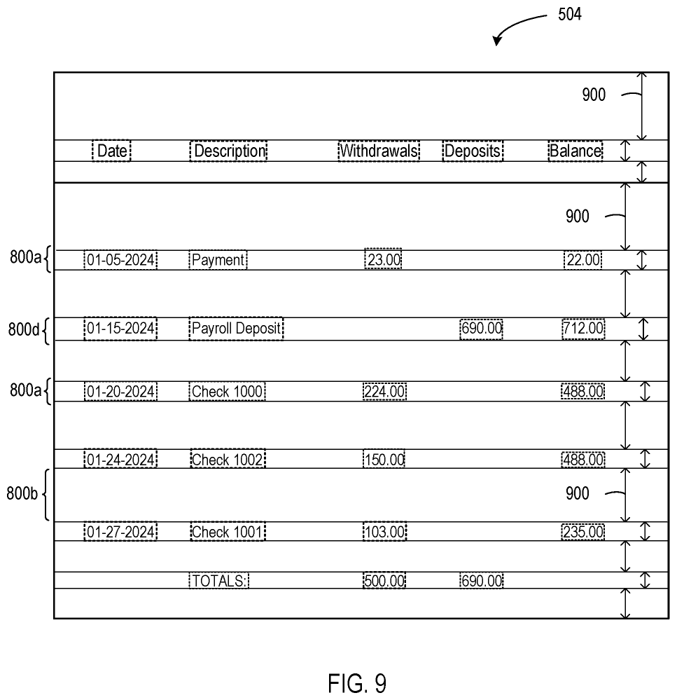

FIG. 8 illustrates an expanded view of the lower portion of the example document shown in FIG. 6 with horizontal boxes and vertical boxes in accordance with an embodiment of the disclosure. In the illustrated embodiment, the text bounding boxes 500 are included within the horizontal boxes 800a, while the horizontal boxes 800b do not include any text bounding boxes 500. The horizontal boxes 800b can be used to determine the separation areas between adjacent rows in the table. FIG. 9 illustrates the non-overlapping horizontal boxes shown in FIG. 8 in accordance with an embodiment of the disclosure. For clarity, the vertical boxes have been removed. Each non-overlapping horizontal box is identified by a double-sided arrow 900.

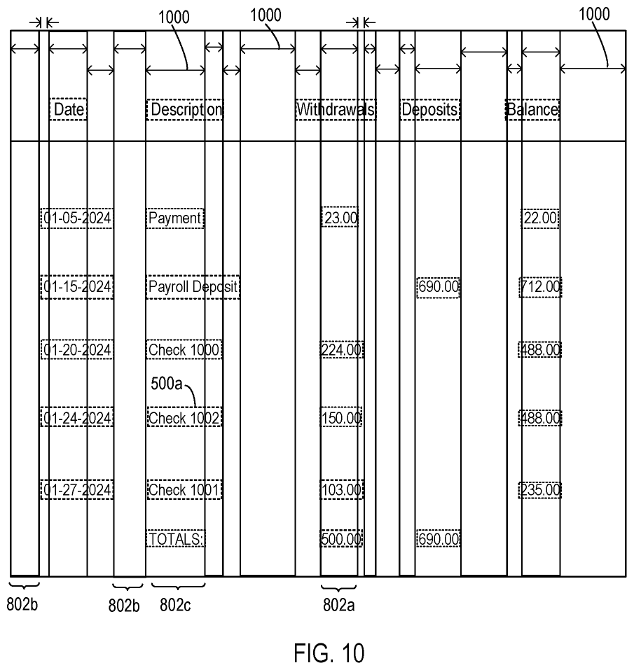

Referring again to FIG. 8, the text bounding boxes 500 are included within the vertical boxes 802a, while the vertical boxes 802b do not include any text bounding boxes 500. The vertical boxes 802b can be used to determine the separation areas between adjacent columns in the table. FIG. 10 illustrates the non-overlapping vertical boxes shown in FIG. 8 in accordance with an embodiment of the disclosure. For clarity, the horizontal boxes have been removed. Each non-overlapping vertical box is identified by a double-sided arrow 1000.

Intersection boxes 804a, 804b, 804c, 804d are also shown in FIG. 8. The intersection box 804a is created by the intersection of the horizontal box 800b and the vertical box 802c. The intersection box 804b is produced by the intersection of the horizontal box 800c and the vertical box 802d. The intersection box 804c is produced by the intersection of the horizontal box 800c and the vertical box 802e. The intersection box 804d is produced by the intersection of the horizontal box 800c and the vertical box 802f.

A non-limiting nonexclusive example of the process of determining the interactions between the text bounding box 500a and the intersection box 804b is now described. In this example, the text bounding box 500a extends across the non-overlapping vertical box 804b. The amount of area of the text bounding box 500a that is within the corresponding intersection box 804b is determined (block 702). When the interaction between the text bounding box 500a and the corresponding intersection box 804b is equal to or greater than the threshold, the text bounding box 500a is associated with the corresponding intersection box 804b (block 708 in FIG. 7). A determination is made that there are additional corresponding intersection boxes 804c, 804d at block 710. The additional corresponding intersection boxes 804c, 804d are not analyzed and are disregarded at block 712. Thus, the method continues at block 714 and repeats for the other corresponding intersection boxes in the lower portion 404 of the document.

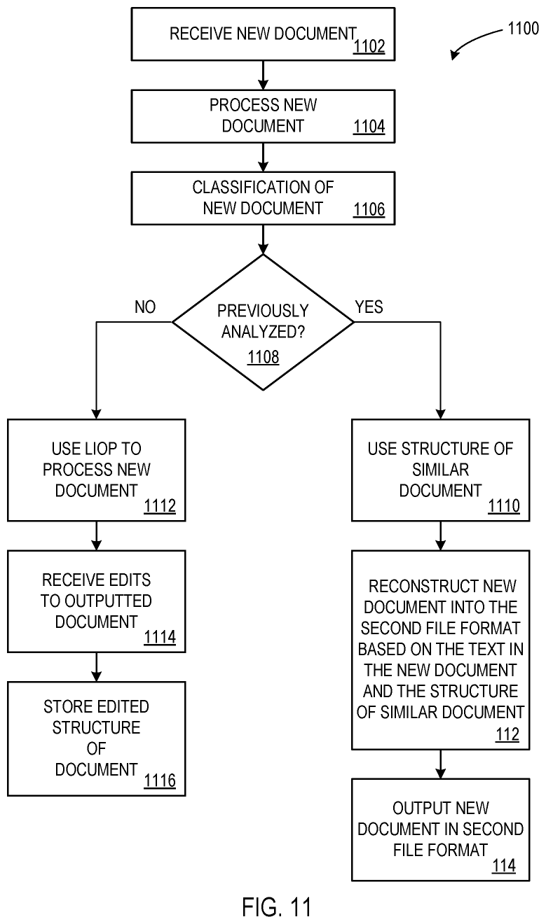

FIG. 11 illustrates a flowchart of an example method of a workflow in accordance with an embodiment of the disclosure. The example method 1100 begins with the receipt of a new document (block 1102). For example, the example document shown in FIG. 4 may be received at block 1102. The new document is processed and a classification process is performed on the new document (block 1104, block 1106). In one embodiment, processing of the new document includes creating text bounding boxes for the text in the document and then extracting the text from the document. An object detection process can be used to produce the text bounding boxes. For example, the NMS process may be used to create the text bounding boxes.

The classification process determines if the new document is similar to a document that has been previously analyzed by the language independent OCR process (LIOP). In one embodiment, the classification process determines if the structure (e.g., the format) of the new document is similar to the structure of any previously analyzed documents (“reference documents”). The reference documents and/or the structure of the reference documents are stored in a memory or database. Extracting the text from the new document prior to classifying the new document enables the classification process to compare the structure of the new document with the structures of the reference documents. Non-limiting nonexclusive examples of a classification process include a cosine similarity algorithm and a k-nearest neighbor (KNN) algorithm.

A determination is made at block 1108 as to whether the new document is similar to one of the reference documents. If a determination is made that the new document is similar to a reference document (“similar document”), the method continues at block 1110 where the structure of the similar document is selected and used to reconstruct the new document into the second file format (block 112). The reconstruction of the new document into the second file format is also based on the text that was extracted from the new document at block 1104. The new document in the second file format is then output at block 114. The operations performed at block 112 and at block 114 were described in more detail in conjunction with FIG. 1.

When a determination is made at block 1108 that the new document is not similar to any of the reference documents, the method passes to block 1112 where the LIOP described herein is performed. At the end of the LIOP, the document is in the second file format. In some embodiments, the document in the second file format can be displayed in a graphical user interface that enables a user to view and modify the document. For example, the NMS process may be performed to create the text bounding boxes for the text, which enables the user to adjust the size or the location of one or more of the text bounding boxes. The user edits to the structure of the new document can be used to further train the LIOP (e.g., to train the LLM). The edited structure (e.g., format) of the new document is then stored as a reference document and used in future classification processes.

In some embodiments, the example workflow 1100 utilizes two application programming interfaces (API). Using a first API, the example workflow 1100 is able to use the structure of a reference document when the structure of the new document is similar to the structure of the reference document. Use of the reference document reduces the amount of time that is needed to produce the document in the second file format. The second API causes the entire LIOP to be performed only when the new document is not similar to a reference document.

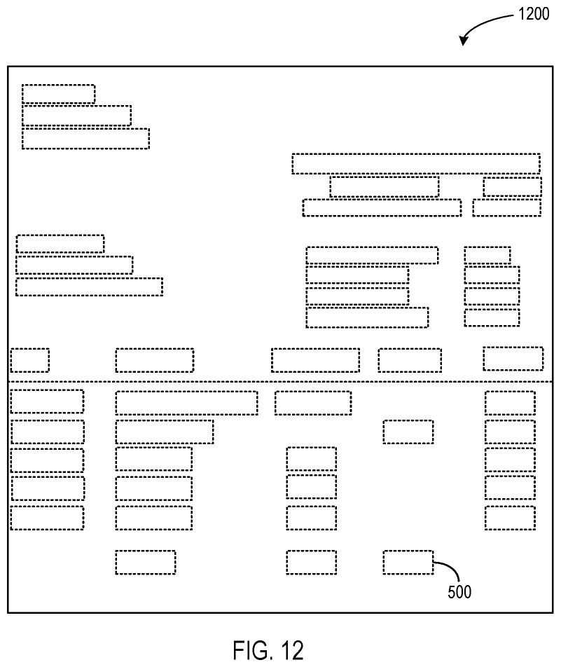

FIG. 12 illustrates the example document shown in FIG. 4 with the text extracted in an embodiment in accordance with the disclosure. In this example, the example document shown in FIG. 4 is the new document that is received at block 1102 in FIG. 11. The example document 1200 in FIG. 12 depicts the document after the document is processed at block 1104 in FIG. 11. The text is extracted from the example document 1200 but the text bounding boxes remain. The locations of the text bounding boxes provides the structure and/or the format of the example document 1200. Thus, the example document 1200 functions as a template for the example document 400 shown in FIG. 4. The structure and/or the format is provided to the classification process at block 1106 to enable the classification process to determine whether the example document 1200 is similar to one of multiple documents that have been processed by the LIOP in the past.

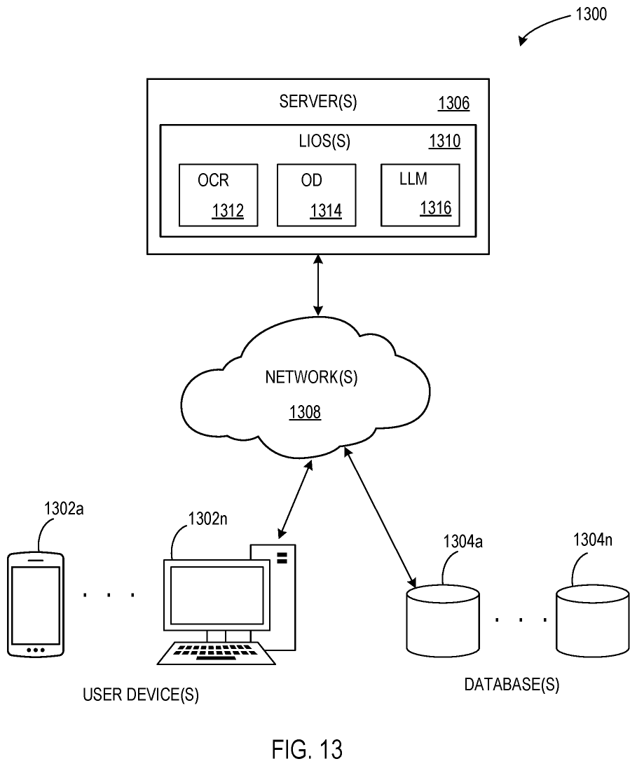

FIG. 13 illustrates an example block diagram of an environment in which a language independent OCR process can operate in accordance with an embodiment of the disclosure. The environment 1300 includes one or more user devices 1302a-n and one or more databases 1304a-n. The environment 1300 can also include one or more servers 1306, which can be in communication with the user device(s) 1302a-n and the database(s) 1304a-n using one or more networks 1308. In some implementations, one or more language independent OCR systems (LIOS) 1310 resides, at least in part on the server(s) 1306, although at least a portion of the LIOS(s) 1310 can also reside elsewhere (e.g., in one or more user device(s) 1302a-n). For example, a user of a user device 1302a can access the LIOS(s) 1310 via the network(s) 1308 to generate, access, or modify various documents, access user interfaces, or the like. The user can provide inputs via the user device 1302a to generate, access, and/or modify a document, to initiate an OCR process, to edit a document during or after the language independent OCR process, and so forth. The documents can be stored in one or more of databases 1304a-n, which can be accessed by the LIOS 1310.

The LIOS 1310 can reside on one or more of the server(s) 1306, such as a web server. In some implementations, the LIOS 1310 can be implemented, at least in part, as a cloud-based system, such as using the one or more server(s) 1306. The LIOS 1310 includes one or more OCR systems 1312, one or more object detection (OD) systems 1314, and one or more LLM systems 1316. As described earlier, the NMS process is an example of an OD process. The OCR system 1312, the OD system 1314, and the LLM system 1316 are used to perform a LIOP on documents, as described herein.

The various components in the environment 1300 can be in communication directly or indirectly with one another, such as through the one or more networks 1308. In this manner, each of the components can transmit and receive data from other components in the environment 1300. For example, the one or more servers 1306 can be in communication with the user device(s) 1302a-n and/or the database(s) 1304a-n over the network(s) 1308. In many instances, the server(s) 1306 can act as a go between for components in the environment 1300.

The one or more networks 1308 can be substantially any type or combination of types of communication systems for transmitting data either through wired or wireless mechanisms (e.g., cloud, WI-FI®, Ethernet, BLUETOOTH®, cellular data, or the like). In some embodiments, certain components in the environment 1300 can communicate via a first mode (e.g., BLUETOOTH®) and others can communicate via a second mode (e.g., WI-FI®). Additionally, certain components can have multiple transmission mechanisms and be configured to communicate data in two or more manners. The configuration of the network(s) 1308 and communication mechanisms for each of the components can be varied as desired.

The one or more servers 1306 includes one or more computing devices that process and execute information. Each of the one or more servers 1306 can include its own processing device, memory, and the like, and/or can be in communication with one or more external components (e.g., separate memory storage). The server 1306 can also include one or more server computers that are interconnected together via the network(s) 1308 or separate communication protocol. The server(s) 1306 can host and execute a number of the processes executed by the LIOS 1312.

The one or more servers 1306 has or offers a number of configurable application programming interfaces (API) that can be accessed and used from an application on a user device 1302a-n to send and receive data to the server(s) 1306. To prevent unauthorized access, applications can be required to authenticate sessions or connections via a license key or other code. Each of the one or more user devices 1302a-n can be one of various types of computing devices, such as smart phones, tablet computers, desktop computers, laptop computers, set top boxes, gaming devices, wearable devices, or the like. The user device(s) 1302a-n provides output to, and receives input from a user. For example, the user device(s) 1302a-n can receive inputs associated with documents, and the user device(s) 1302a-n can output one or more displays, such as displays including documents and graphical user interfaces to edit a document before, during, and after a language independent OCR process. The type and number of user device(s) 1302a-n can vary as desired.

The one or more database 1304a-n store data that can be used by the server(s) 1306. The database(s) 1304a-n can be stored on the server(s) 1306 and/or can be separate structures accessible by the server(s) 1306 as needed. The database(s) 1304a-n can store various data associated with documents. As another example, third party databases can be accessed, for example, that contain public or other accessible information related to documents. In some instances, the environment 1300 can include a combination of managed and third-party databases.

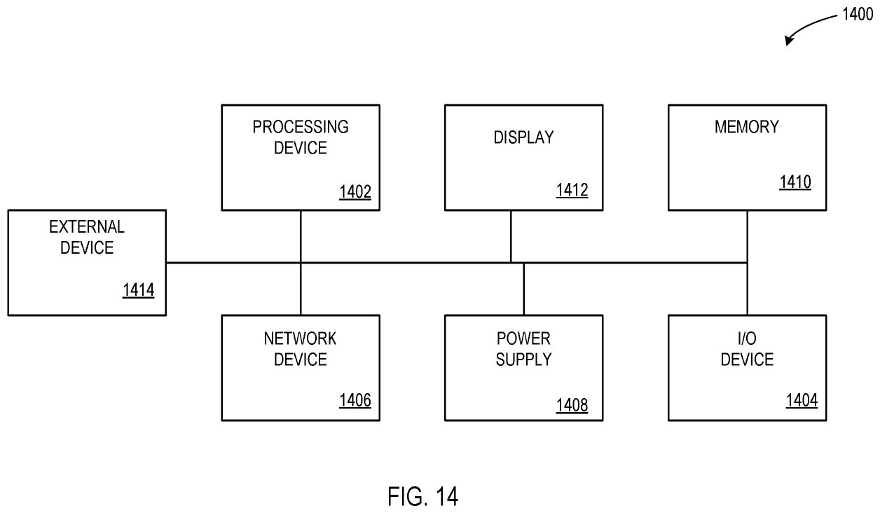

FIG. 14 illustrates an example block diagram of a computing device in accordance with an embodiment of the disclosure. The computing device 1400 can be, for example, one or more server(s) 1306 and/or one or more user devices 1302a-n (FIG. 13), and/or the computing device 1400 can host and/or access one or more databases 1304a-n. The computing device 1400 can include components comprising one or more of the following: a processing device 1402, an input/output device 1404, a network device 1406, a power supply 1408, a memory 1410, a display 1412, and/or an external device 1414. Each of the components can be in communication with one another through one or more busses, wireless means, or the like.

The processing device 1402 can be any type of electronic device capable of processing, receiving, and/or transmitting instructions and data. For example, the processing device 1402 can be a central processing unit, a microprocessor, a processor, a microcontroller, a graphical processing unit, and/or a combination of multiple processing devices. For example, a first processing device can control a first set of components of the computing device and a second processing device can control a second set of computing devices, where the first and second processing devices may or may not be in communication with one another. Additionally, the processing device 1402 can be configured to execute one or more instructions in parallel and across a network (e.g., network(s) 1308 in FIG. 13), such as through cloud computing resources.

The input/output (I/O) device 1404 receives and transmits data to and from the network(s) 1308. The I/O device 1404 allows a user to enter data into the computing device 1400, as well as provides an input/output for the computing device 1400 to communicate with other devices (e.g., server(s) 1306, other computers, speakers, etc.). The I/O device 1404 can include one or more input buttons, touch pads, touchscreens, keyboards, and so on. For example, the computing device 1400 can receive inputs via the I/O device 1402 related to one or more language independent OCR processes, and the I/O device 1404 can be used to provide outputs of the system, such as documents before, during, and/or after the performance of a language independent OCR process and graphical user interfaces that enable a user to edit such documents.

The network device 1406 provides communication to and from the computing device 1400 to other devices. For example, the network device 1406 allows the server(s) 1306 to communicate with the user device(s) 1302a-n through the network(s) 1308. The network device 1406 can use one or more communication protocols, such as, but not limited to WI-FI®, Ethernet, BLUETOOTH®, and so on. The network device 1406 can also include one or more hardwired components, such as a Universal Serial Bus cable, or the like. The configuration of the network device 1406 depends on the types of communication desired and can be modified to communicate via WI-FI®, Ethernet, BLUETOOTH®, and so on.

The power supply 1408 provides power to various components of the computing device 1400. The power supply 1408 can include one or more rechargeable, disposable, or hardwire sources, e.g., batteries, power cords, or the like. Additionally, the power supply 1408 can include one or more types of connectors or components that provide different types of power to the computing device 1400. In some embodiments, the power supply 1408 can include a connector (such as a universal serial bus connector) that provides power to the computing device 1400 or batteries within the computing device 1400 and also transmits data to and from the device to other devices.

The memory 1410 is operable to store electronic data, such as, for example, documents, OCR processes, analytical process (e.g., LLMs), and the like, that can be utilized by the computing device 1400. The memory 1410 can include electrical data or content, such as processor instructions (e.g., software code), audio files, video files, document files, and the like. The memory 1410 can include multiple components, such as, but not limited to, non-volatile storage, a magnetic storage medium, an optical storage medium, a magneto-optical storage medium, a read only memory, a random access memory, an erasable programmable memory, a flash memory, or a combination of one or more types of memory components. In many embodiments, the one or more servers 1306 (FIG. 13) can have a larger memory capacity than the user devices 1302a-n.

The display 1412 provides visual feedback to a user and, optionally, can act as an I/O device to enable a user to control, manipulate, and calibrate various components of the computing device 1400. The display 1412 can be a liquid crystal display, a plasma display, an organic light-emitting diode display, and/or a cathode ray tube display. In embodiments where the display 1412 is used as an I/O device, the display 1412 can include one or more touch or input sensors, such as capacitive touch sensors, a resistive grid, or the like.

The external device 1414 can be one or more devices that can be used to provide various inputs to the computing device 1400. Example external devices 1414 include, but are not limited to, memory devices, I/O devices, computing devices, and the like. The external device 1414 can be local or remote and can vary as desired.

It should be noted that the computing device 1400 can be in communication with a compute back end, such as the server(s) 1306 (FIG. 13) or a cloud provider, e.g., Google Cloud Platform, Amazon Web Services, Microsoft Azure, or the like.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
detecting a table in a document, wherein the document is language dependent;
detecting text in the table;
determining structural information for the table;
extracting the text from the table;
converting the document into a first file format, wherein the first file format is a structured file format and the document in the first file format is language independent;
reconstructing the document into a second file format wherein the table is reconstructed based on the text extracted from the table and the structural information; and
outputting the document.

2. The method of claim 1, wherein determining the structural information for the table comprises detecting locations of the text in the table.

3. The method of claim 2, wherein detecting the locations of the text in the table comprises creating, with an object detection process, bounding boxes around the text.

4. The method of claim 1, wherein determining the structural information for the table comprises:
creating vertical lines and horizontal lines along a periphery of each bounding box;
detecting non-overlapping vertical boxes and non-overlapping horizontal boxes in the table;
determining an amount of an area of a respective bounding box that is within an area of a respective intersection box, the intersection box defined by an intersection of a respective vertical box and a respective horizontal box; and
associating the respective bounding box to the respective intersection box when the amount of the area of the respective bounding box that is within the area of the respective intersection box is greater than a threshold.

5. The method of claim 4, wherein determining the amount of the area of the respective bounding box that is within the area of the respective intersection box comprises determining, using an intersection over union process, the amount of the area of the respective bounding box that is within the area of the respective intersection box.

6. The method of claim 1, wherein detecting the text in the document comprises detecting, using an optical character recognition process, the text in the document.

7. The method of claim 1, further comprising pre-processing the document prior to detecting the text in the document, the pre-processing comprising performing at least one of:
a noise reduction process;
a thresholding process;
a skew correction process;
a normalization process; or
a sharpening process.

8. The method of claim 1, wherein outputting the document comprises at least one of:
transmitting the document to a computing device;
displaying the document on a display device; or
storing the document in a memory.

9. The method of claim 8, wherein displaying the document on the display device comprises displaying the document in a user interface on the display device, the user interface configured to receive a user input to modify the document.

10. A method, comprising:
receiving a document;
determining if the document is similar to one of a plurality of reference documents;
based on a determination that the document is similar to the one of the plurality of reference documents, reconstructing the document into a first file format based on the text in the document and the reference document; and
based on a determination that the document is not similar to the one of the plurality of reference documents:
detecting a table in the document;
detecting text in the table;
determining structural information for the table, the determining comprising detecting locations of the text in the table;
extracting the text from the table;
converting the document into a first file format, wherein the first file format is a structured file format and the document in the first file format is language independent;
reconstructing the document into a second file format, wherein the table is reconstructed based on the text extracted from the table and the structural information; and
outputting the document.

11. The method of claim 10, wherein determining if the document is similar to one of a plurality of reference documents comprises:
creating bounding boxes around the text in the document;
extracting the text from the document to create a template of the document; and
performing a classification process using the template of the document and the plurality of reference documents.

12. The method of claim 10, further comprising:
after reconstructing the document into the first file format based on the text in the document and the reference document, displaying the document in a user interface on a display;
receiving, via the user interface, an edit to the document; and
storing the edited document.

13. The method of claim 10, wherein outputting the document comprises at least one of:
transmitting the document to a computing device;
displaying the document on a display device; or
storing the document in a memory.

14. The method of claim 10, wherein the determining of the structural information further comprises:
creating vertical lines and horizontal lines along a periphery of each bounding box;
detecting non-overlapping vertical boxes and non-overlapping horizontal boxes in the table;
determining an amount of an area of a respective bounding box that is within an area of a respective intersection box, the intersection box defined by an intersection of a respective non-overlapping vertical box and a respective non-overlapping horizontal box; and
associating the respective bounding box to the respective intersection box when the amount of the area of the respective bounding box that is within the area of the respective intersection box is greater than a threshold.

15. The method of claim 10, wherein detecting the locations of the text in the table comprises creating, with an object detection process, bounding boxes around the text.

16. The method of claim 10, wherein detecting the text in the table comprises detecting, using an optical character recognition process, the text in the document.

17. A system, comprising:
a processing device; and
a memory operable to store instructions, that when executed by the processing device, cause operations to be performed, the operations comprising:
detecting, using an optical character recognition process, text in a table in a document;
creating, using an object detection process, bounding boxes around each text in the table;
determining structural information for the table, the determining comprising:
detecting rows in the table;
detecting columns in the table; and
detecting a location of each respective bounding box in a respective row and a respective column, where the detected rows, the detected columns, and the locations of the bounding boxes comprises structural information;
extracting the text from the table;
converting the document into a first file format, wherein the first file format is a structured file format and the document in the first file format is language independent;
reconstructing, using a large language model, the document into a second file format, wherein the table is reconstructed based on the text extracted from the table and the structural information; and
outputting the document.

18. The system of claim 17, wherein reconstructing, using the large language model, the document into the second file format comprises reconstructing, using the large language mode, the table into the second file format based on the text extracted from the table and the structural information.

19. The system of claim 17, wherein outputting the document comprises at least one of:
transmitting the document to a computing device;
displaying the document on a display device; or
storing the document in a memory.

20. The system of claim 19, wherein displaying the document on the display device comprises displaying the document in a user interface on the display device, the user interface configured to receive a user input to modify the document.
